(19) United States
(12) Patent Application Publication
(10) Pub. No.: US 2020/0031004 A1
(43) Pub. Date: Jan. 30, 2020

(54) PORTABLE HAIR REMOVAL APPARATUS

(71) Applicant: Church & Dwight Co., Inc., Ewing, NJ (US)

(72) Inventors: Anand Khubani, Morristown, NJ (US); Eric Langberg, Milford, PA (US); David Stowers, Morristown, NJ (US)

(21) Appl. No.: 16/524,909

(22) Filed: Jul. 29, 2019

Related U.S. Application Data
(60) Provisional application No. 62/712,202, filed on Jul. 30, 2018.

(51) Int. Cl. B26B 19/46; B26B 19/38

(52) U.S. Cl. CPC B26B 19/46; B26B 19/146; B26B 19/3873; B26B 19/386

(57) ABSTRACT

A hair removal apparatus has a drive unit, a handle that allows a user to easily grip the apparatus, and a shaving unit that allows the apparatus to adjust to the contours of a shaving surface.

### RELATED APPLICATION

This is a utility of the provisional application of U.S. Application Ser. No. 62/712,202 filed on Jul. 30, 2018 and entitled “Portable Shaving Apparatus”.

### BACKGROUND OF THE INVENTION

### Field of the Invention

This invention relates to a portable shaving apparatus and more specifically to a portable shaving apparatus having a one head to multiple head design with an ergonomic handle design with a grip, a detachable drive unit, and a detachable shaving unit allow for a design that prevents debris, dead skin, dirt, oil, and water from interfering with optimal performance of the shaving apparatus as well as making the shaving inoperable or broken. The design further allows a user to easily wash the shaving unit with water for cleaning and optimal performance.

### SUMMARY OF THE INVENTION

In an embodiment of the invention a shaving apparatus comprising a handle having an internal cavity that contains a power source, a motor, a transmission, a drive, and at least one light source, the handle also has a top and bottom surface; a drive unit having a sealed cavity that contains a gear system, the drive unit having a top and bottom surface; a shaving unit having at least one shaving head, a flex surface, a frame, and a frame lock; and wherein the handle connects to the drive unit allowing the drive to provide power to the gear system of the drive unit, and wherein the drive unit connects to the shaving unit allowing the gear system to provide power to at least on shaving head.

In another embodiment, wherein the power source supplies power to the motor and the at least one light source. In yet another embodiment, the apparatus having a second light source powered the power source. In a further embodiment, wherein the power source is chosen from a group comprising a disposable battery, a rechargeable battery, a solar cell, and combinations thereof.

In still another embodiment, the sealed cavity of the drive unit prevents debris from entering the gear system. In a further embodiment, the sealed cavity of the drive unit prevents debris, dirt, hair trimming, skin cells, and water from entering the gear system and preventing operation of the shaving apparatus.

In another embodiment, the handle has a raised collar with at least one protrusion which is designed to be received by a raised circular wall with notches on the drive unit to create a detachable connection between the handle and the drive unit.

In still another embodiment, the drive unit has a drive that is designed to be received by a drive head receiver of the drive unit which transmits power to the gear system. In yet another embodiment, the drive unit has at least one subhead that is attached to the gear system that is received by a sub head receiver of the shaving head providing power to the at least one shaving head.

In a further embodiment, the drive unit has at least four subheads that are attached to the gear system that is received by sub head receivers of the shaving head providing power to the at least four shaving heads.

In another embodiment, the shaving unit has a sprung frame that holds the at least one shaving head in place with a frame lock and allows the flex surface of the one shaving unit to adjust to contours of a surface being shaved by a user. In still another embodiment, the shaving unit has a sprung frame that holds the at least four shaving heads in place with a frame lock and allows the flex surfaces of the at least four shaving units to adjust to contours of a surface being shaved by a user.

In yet another embodiment, the gear system of drive unit that has a subhead that is designed to be received by the sub head receiver.

In a further embodiment, the handle has a continuous grip to allow a user to easily hold the apparatus. In another embodiment, the handle has a charging port to recharge the power source. In still another embodiment the handle has a charge indicator to allow a user to know that the apparatus is charging. In yet another embodiment, the handle has a charge indicator to allow a user to know that the apparatus is charged and needs to be charged.

In a further embodiment, the apparatus has at least two shaving heads. In another embodiment, the apparatus has at least three shaving heads. In yet a further embodiment, the apparatus has at least four shaving heads. In yet another embodiment, an apparatus wherein the handle has a flat top, a flat bottom, and flat sides that are curved where the flat sides meet the flat top and the flat bottom making the handle easy to grip for a user.

### BRIEF DESCRIPTION OF THE DRAWINGS

The accompanying drawings are included to provide a further understanding of the present invention. These drawings are incorporated in and constitute a part of this specification, illustrate one or more embodiments of the present invention and together with the description, serve to explain the principles of the present invention.

FIG. 1 is top view of the shaving apparatus.

FIG. 2 is a side view of the shaving apparatus showing handle, inset grip, drive unit and shaving unit.

FIG. 3 is a view that shows the charging port and charge indicator.

FIG. 4 is a view of the shaving unit.

FIG. 5 is a bottom view of the shaving device.

FIG. 6 shows the drive unit.

FIG. 7 shows the shaving unit with frame, sub head receiver, and frame lock.

FIG. 8 shows the sealed drive unit and the sub drive.

FIG. 9 shows the shaving unit, shaving head, and the flex surface.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### DETAILED DESCRIPTION OF THE INVENTION

As required, detailed embodiments of the present invention is disclosed herein, however, it is to be understood that the disclosed embodiments are merely exemplary of the invention that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

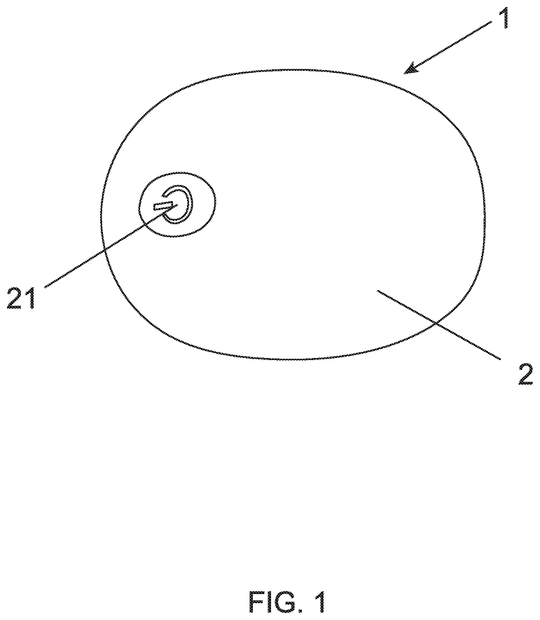

FIG. 1 shows the top of the shaving apparatus 1 having a handle 2 and a power button 21 located on the top surface of that handle 2. The power button 21 allows a user to turn the shaving apparatus on and off.

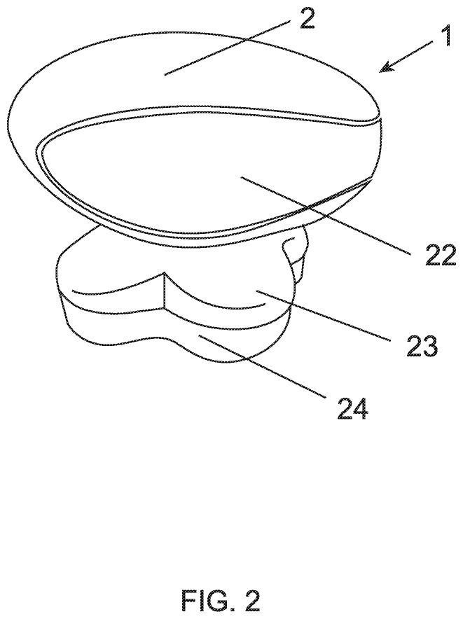

FIG. 2 shows the shaving apparatus 1 from the side having a handle 2 with a grip 22 made of a material that allows a user to securely and easily grip the shaving apparatus 1. The material can be made from silicone or similar material that allows for increased grip by having a surface which is either depressible, tacky, textured, or combinations thereof. FIG. 2 further shows the drive unit 23 and shaving unit 24 removably attached to one another and also attached to the handle 2. The drive unit 23, shaving unit 24, and handle 2 can be easily separated for storage and cleaning. The handle 22 has an internal cavity that contains a motor, power source, transmission, lights, and circuitry (not shown). The power source provides power to the motor and lights. The motor and transmission are connected to one another, and the transmission is attached to the drive 32 (not shown). The transmission transmits the power motion to the drive 32.

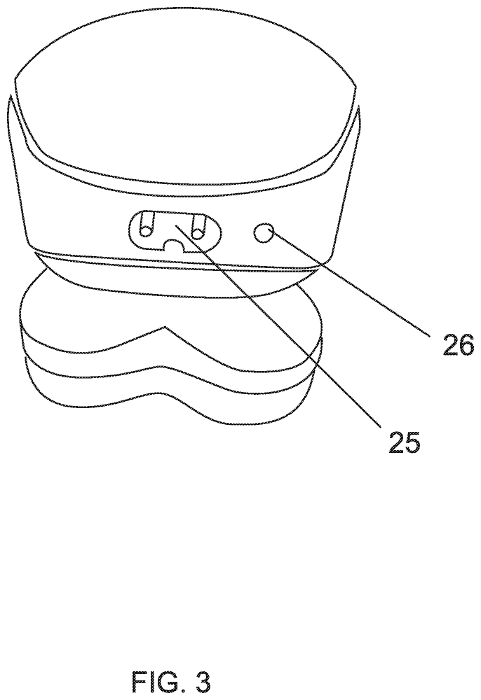

FIG. 3 shows the charge port 25 which allows a user to recharge the power source. There is also, a charge indicator 26 which has a light that indicates the state of the shaving apparatus charge status. The charge indicator 26 tells a user if the shaving apparatus 1 is charging, charged, or needs to be charged.

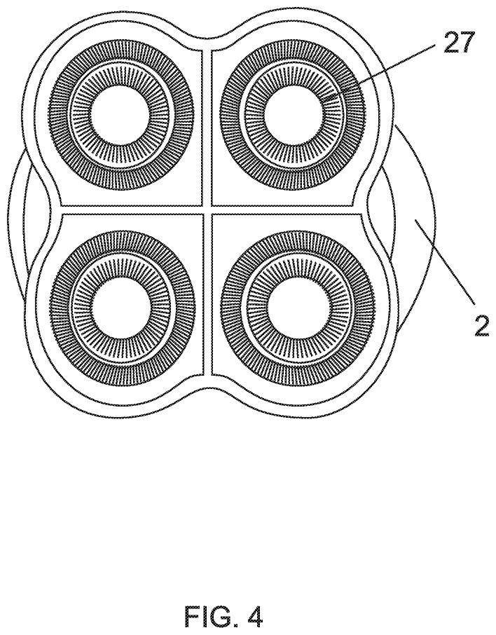

FIG. 4 shows the drive unit 23 and four shaving heads 27. FIG. 4 further shows the how at least part of the handle 2 extends over the perimeter of the drive unit 23 and the shaving heads 27.

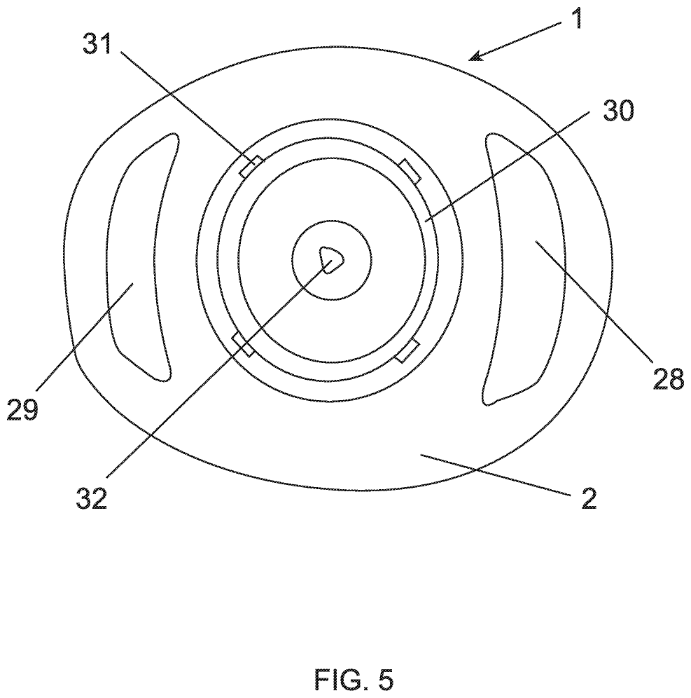

FIG. 5 shows the bottom of the handle 2 of the shaving apparatus having translucent, frosted, or clear windows that allow lights 28, 29 to light the surface that is being shaved by the user. It further shows the drive 32, the collar 30 and protrusion 31 of the handle which are received by the drive receiver 33, the wall 34, notch 35 of the drive unit 23. The drive 32 transmits motion and power to the gear system (not shown) of the drive unit 23.

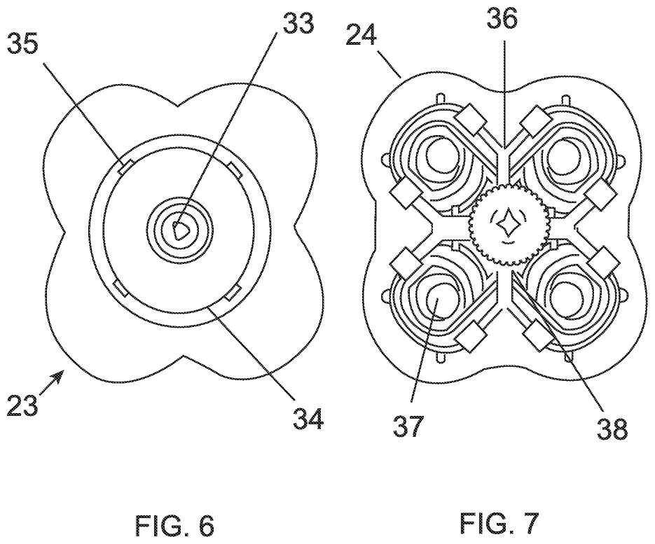

FIG. 6 shows the drive unit 23 having a drive receiver 33, wall 34, and notch 35 which receive the drive 32, the collar 30 and protrusion 31 of the handle 2. FIG. 6 further shows that there are four notches 35, these four notches are spaced apart equally relative to one another. The four notches 35 correspond in arrangement with the four protrusions 31 that are shown in FIG. 5. The notch 35 and protrusion 31 configuration allows the drive unit 23 and handle 2 to always be put together correctly by having four of both the notches 35 and protrusions 31 allows the drive unit 23 to clip on to the handle 2 in any of four possible positions and always be correctly aligned with one another. The notch 35 and protrusion 31 arrangement makes the handle 2 and drive unit 23 self-aligning when they are being connected. FIG. 5 also shows how the drive unit 32 is sealed and lacks any opening or exposed areas that would prevents dirt, debris, skin, hair, skin oils, or water into the gear system (not shown) that it contains.

FIG. 7 shows the shaving unit 24 with a resilient or sprung frame 36 which is kept in place by drive lock 38. The frame 36 biases the shaving head(s) 27 against the flex surface 40 of the shaving unit. This allows the movable flex surface 40 to adjust to the contours of a user's body

while they use the shaving apparatus 1. FIG. 7 also shows the open design of the shaving unit 24 that allows a user to shake out or rinse the frame 36, subhead receivers 37, and shaving heads 27 for cleaning. The drive lock 38 can be undone by the user to allow them to separate the frame 36 from the shaving heads 27 to aid in the cleaning process.

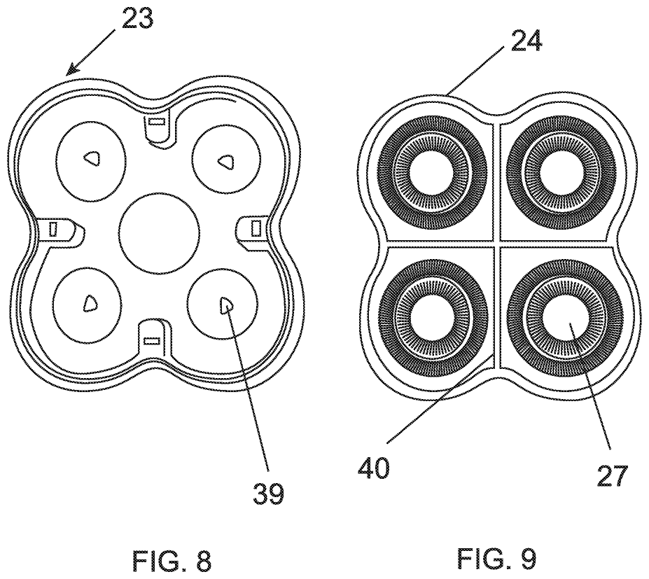

FIG. 8 shows the unit 23 and the exposed sub heads 39 that are designed to be received by the sub head receivers 37 of the shaving unit 24. The sub heads 39 are powered by the gear system (not shown) of the drive unit and power the shaving heads 27.

FIG. 9 shows the shaving unit 23, shaving heads 27, and the flex surface 40.

What is claimed is:

1. A shaving apparatus comprising:
a handle having an internal cavity for containing a power source, a motor, a transmission, a drive, and at least one light source;
a drive unit comprising a gear system;
a shaving unit having at least one shaving head, a flex surface, a frame, and a frame lock, said handle being connected to said drive unit, said drive unit being connected to said shaving unit, said gear system of said drive unit provides power to said apparatus to thereby allow said shaving head to move and cut a user's hair.

2. The apparatus of claim 1 further comprising a power source, a motor, a transmission, a drive, and at least one light source configured to illuminate a shaving surface during use.

3. The apparatus of claim 2 wherein said power source supplies power to said motor and said at least one light source.

4. The apparatus of claim 2 having a second light source configured to illuminate said shaving surface and powered by said power source.

5. The apparatus of claim 2 wherein said power source is chosen from a group comprising a disposable battery, a rechargeable battery, a solar cell, and combinations thereof.

6. The apparatus of claim 1 wherein said drive unit comprises a sealed cavity, said sealed cavity prevents debris dirt, hair trimmings, skin cells, and water from entering said gear system and preventing operation of said shaving apparatus.

7. The apparatus of claim 1 wherein said handle has a raised collar with at least one protrusion designed to be received by a raised circular wall with notches on said drive unit to create a detachable connection between said hand and said drive unit.

8. The apparatus of claim 1 wherein said drive unit further comprises a drive receiver configured to engage with said drive and transmit power from said gear system.

9. The apparatus of claim 1 wherein said drive unit has at least one subhead attached to said gear system to provide power and wherein said shaving head comprises a subhead receiver configured to receive said subhead and thereby receive said power.

10. The apparatus of claim 1 wherein said shaving unit has a sprung frame that holds said at least one shaving head in place with a frame lock and allows said flex surface of said one shaving unit to adjust to contours of a surface being shaved by a user.

11. The apparatus of claim 1 wherein said shaving head comprises a sub head receiver, said gear system of said drive unit has a subhead that is designed to be received by said sub head receiver of said shaving unit.

12. The apparatus of claim 1 wherein said handle has a continuous grip to allow a user to easily hold said apparatus.

13. The apparatus of claim 1 wherein said handle has a charging port to recharge said power source.

14. The apparatus of claim 1 wherein said handle has a charge indicator to allow a user to know that said apparatus is charging.

15. The apparatus of claim 1 wherein said shaving unit has at least two shaving heads.

16. The apparatus of claim 1 wherein said shaving unit has at least three shaving heads.

17. The apparatus of claim 1 wherein said shaving unit has at least four shaving heads.

18. The apparatus of claim 1 wherein the handle has a flat top, a flat bottom, and flat sides that are curved where said flat sides meet said flat top and said flat bottom making said handle easy to grip for a user.

19. A shaving apparatus comprising:
a handle having an internal cavity;
a power source, a motor, a transmission, a drive, and at least one light source situated within said internal cavity and configured to illuminate a shaving surface;
a drive unit comprising a gear system; and
a shaving unit having at least one shaving head, a flex surface, a frame, and a frame lock, said handle being connected to said drive unit, said drive unit being connected to said shaving unit, said gear system of said drive unit provides power to said apparatus to thereby allow said shaving head to move and cut a user's hair.

20. A shaving apparatus comprising:
a handle having an internal cavity for containing a power source, a motor, a transmission, a drive, and at least one light source;
a drive unit comprising a gear system, said drive unit having a sealed cavity; and
a shaving unit having at least one shaving head, a flex surface, a frame, and a frame lock, said handle being connected to said drive unit, said drive unit being connected to said shaving unit, said gear system of said drive unit provides power to said apparatus to thereby allow said shaving head to move and cut a user's hair.

21. The shaving apparatus of claim 20 wherein said handle has a raised collar with at least one protrusion designed to be received by a raised circular wall with notches on said drive unit to create a detachable connection between said hand and said drive unit that is self-aligning.
